(19) United States
(12) Patent Application Publication
(10) Pub. No.: US 2005/0020245 A1
(43) Pub. Date: Jan. 27, 2005

(54) METHOD AND DEVICE FOR WIRELESS DATA TRANSMISSION AND STORAGE

(76) Inventors: Ching-Jun Su, Taipei Hsien (TW); Chu-Chia Tsai, Taipei Hsien (TW); Jia-Ming Li, Taipei Hsien (TW); Jiann-Jou Chen, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,273

(22) Filed: Sep. 19, 2003

(30) Foreign Application Priority Data
Jul. 21, 2003 (TW) 092119875

(51) Int. Cl. H04Q 7/20

(52) U.S. Cl. 455/412.1

(57) ABSTRACT

Method and device for wireless data transmission and storage. The device is a remote wireless data storage system including a remote data processing subsystem for receiving an audio signal and a central data processing subsystem for data storage. The remote data processing subsystem sends information corresponding to the audio signal to the central data processing subsystem through wireless transmission, and the central data processing subsystem stores the information. Furthermore, the remote data processing subsystem receives stored information corresponding to an audio signal from the central data processing subsystem through wireless transmission and outputs a reconstructed audio signal corresponding to the stored information.

### BACKGROUND OF INVENTION

1. Field of the Invention

The present invention relates to a method and a device for wireless data transmission and storage, and more particularly, to a wireless audio recorder and related method.

2. Description of the Prior Art

As business develops, inter-corporate meetings become important affairs of businessmen. During a meeting, the lights might be turned off due to usage of projectors, and moreover, the trips are rushed so that the content of issues of the meeting cannot be recorded in detail. Therefore, audio recording becomes a practical way to record.

Conventional audio recording devices are not handy. Even the smallest Walkman can be put into a pocket, and then the pocket is fully occupied. A recording pen (a pen-like digital recorder with storage media such as semiconductor memory chips) is indeed handy, but the price of the recording pen is proportional to the storage volume of the memory so that the recording time corresponding to a reasonable price of the recording pen is limited. As a result, a computer system is needed as a final storage device, and this leads to inconvenience. Firstly the user have to electrically connect the recording pen to the computer system (such as a laptop) with a transmission cable. Secondly data corresponding to recorded audio information should be transmitted to the computer system through the transmission cable and then the old data in the recording pen should be deleted to make room for further use. Some better version of the recording pen transmits and deletes the data automatically while the electric connection between the recording pen and the computer system is established. However, waiting for the abovementioned data processing of the recording pen might interrupt the meeting so that the above-mentioned data processing is not allowed while there is no room for further recording. Furthermore, if a laptop with audio recording functionality is provided, a microphone installed in the laptop is not handy while an external microphone (having a cable connecting to the laptop) limits the movement of the user during the meeting.

The present invention solves the above-mentioned problem with computer system related apparatuses, and some audio processing apparatuses installed in computer systems according to the prior art will be described in the following paragraphs. As the calculation speed of computer systems increases, audio-video processing using the computer systems become popular. However, complex operations of user interfaces of computer systems hinder the enjoyment provided by the audio-video processing ability of the computer systems. Therefore, some producers provide simplified systems with apparatuses similar to well-known computer systems and with user-friendly interfaces while the audio-video processing ability, which is not available in conventional audio-video systems, is preserved. Of concern, the definition of the computer system in the present invention not only includes the well-known computer systems, but also includes the simplified systems with apparatuses similar to the well-known computer systems.

Please refer to FIG. 1 showing a block diagram of an audio processing apparatus installed in a computer system 100 according to the prior art. The computer system 100 includes an audio I/O (input/output) module 104 (such as an audio processing interface card or an internal audio processing module of the computer system 100) electrically connected to a microphone 102 for receiving an audio signal, a CPU 106 (Central Processing Unit) electrically connected to the audio I/O module 104 for processing the audio signal received by the audio I/O module 104 to generate storage data, and a storage device 108 electrically connected to the CPU 106 for storing the storage data generated by the CPU 106. Furthermore, the CPU 106 can process the storage data retrieved from the storage device 108 to generate a reconstructed audio signal. The audio I/O module 104, electrically connected to a speaker 110, can output the reconstructed audio signal. The apparatus illustrated in FIG. 1 includes the functionality of a basic computer system, wherein the microphone 102 can be installed in the computer system 100 and become a part of the audio I/O module 104 while the speaker 110 can be installed in the computer system 100 and become a part of the audio I/O module 104. The speaker 110 can be replaced with an earphone.

Please refer to FIG. 2 showing a block diagram of an audio processing apparatus installed in a computer system 200 according to the prior art. The computer system 200 includes an audio I/O (input/output) module 204 (such as an audio processing interface card or an internal audio processing module of the computer system 200) electrically connected to a microphone 202 for receiving an audio signal, a transmission processor 206 (such as the South Bridge chipset) electrically connected to the audio I/O module 204 for transmitting the audio signal received by the audio I/O module 204 while generating transmission data, a CPU 208 electrically connected to the transmission processor 206 for processing the transmission data generated by the transmission processor 206 to generate storage data, and a storage device 210 electrically connected to the transmission processor 206 for storing the storage data generated by the CPU 208. The transmission processor 206 can perform bidirectional transmission between any two elements electrically connected to the transmission processor 206. For simplicity, the description of the bidirectional transmission performed by the transmission processor 206 will not be repeated in the following. Furthermore, the CPU 206 can process the storage data retrieved from the storage device 210 to generate a reconstructed audio signal. The audio I/O module 204, electrically connected to a speaker 212, can output the reconstructed audio signal. The apparatus illustrated in FIG. 2 includes the functionality of an advanced computer system, wherein the microphone 202 can be installed in the computer system 200 and become a part of the audio I/O module 204 while the speaker 212 can be installed in the computer system 200 and become a part of the audio I/O module 204. The speaker 212 can be replaced with an earphone. The earlier versions of the computer system 200 rely on the CPU 208 to process the audio information while the updated versions of the computer system 200 can process the audio information with the audio I/O module 204, implemented with an Audio CODEC (Coder-Decoder) chipset. Therefore, the CPU 208 and related processing steps can be omitted in updated versions of the computer system 200.

Please refer to FIG. 3 showing a block diagram of an audio processing apparatus installed in a computer system 300 according to the prior art. The components and related functionalities of the apparatus of FIG. 3 are similar to the components and related functionalities of the apparatus of FIG. 2 except that the computer system 300 further includes a storage processor 314 electrically connected to the storage device 310 for controlling the storage device 310 and all related data inputted and outputted. Furthermore, the storage processor 314 not only can perform bidirectional transmission to and from any component electrically connected to the transmission processor 306 through the transmission processor 306, but also can perform bi-directional transmission to and from the audio I/O module 304 as needed. When the computer system 300 is in a power-off state, the transmission processor 306, the storage device 310, and the storage processor 314 operate as usual to maintain the operation of the storage device 310.

For a businessman, although the aforementioned recording pen is handy enough to provide the convenient audio recording during a meeting, the recording time is limited so that connecting the recording pen to a computer system for data storage with a transmission cable and deleting the old data stored in the recording pen for further use are required. Usually, waiting for the abovementioned data processing of the recording pen might interrupt the meeting so that the above-mentioned data processing is not allowed while there is no room for further recording. Furthermore, a computer system (such as a laptop) cannot provide the audio recording functionality wirelessly. To summarize, the audio recording tools for the businessman should be improved to meet the detailed recording requirement of a meeting.

### SUMMARY OF INVENTION

It is therefore a primary objective of the claimed invention to provide a method and a device for wireless data transmission and storage to solve the above-mentioned problem.

According to the claimed invention, a remote wireless data storage system for wireless data transmission and storage is provided. The remote wireless data storage system comprises a remote data processing subsystem for receiving an audio signal. The remote data processing subsystem comprises an audio signal input module for receiving the audio signal, a first processor electrically connected to the audio signal input module for processing the audio signal received by the audio signal input module to generate transmission data, and a first wireless transmission module electrically connected to the first processor for wireless transmission of the transmission data. The remote wireless data storage system further comprises a central data processing subsystem for data storage. The central data processing subsystem comprises a second wireless transmission module for receiving the transmission data from the first wireless transmission module, a second processor electrically connected to the second wireless transmission module for processing the transmission data received by the second wireless transmission module to generate storage data, and a storage device electrically connected to the second processor for storing the storage data generated by the second processor.

According to the claimed invention, further provided is a remote wireless data storage system for wireless data transmission and storage. The remote wireless data storage system comprises a remote data processing subsystem for receiving an audio signal. The remote data processing subsystem comprises an audio signal input module for receiving the audio signal, a first processor electrically connected to the audio signal input module for processing the audio signal received by the audio signal input module to generate transmission data, and a first wireless transmission module electrically connected to the first processor for wireless transmission of the transmission data. The remote wireless data storage system further comprises a central data processing subsystem for data storage. The central data processing subsystem installed in a computer system comprises a second wireless transmission module for receiving the transmission data from the first wireless transmission module, a second processor electrically connected to the second wireless transmission module for processing the transmission data received by the second wireless transmission module to generate digital data, a third processor electrically connected to the second processor for processing the digital data received from the second processor to generate storage data, and a storage device electrically connected to the third processor for storing the storage data generated by the third processor.

The claimed invention also provides a data storage method using a remote wireless data storage system, wherein the remote wireless data storage system comprises a remote data processing subsystem and a central data processing subsystem, the remote data processing subsystem comprises an audio signal input module, a first processor, and a first wireless transmission module, and the central data processing subsystem comprises a second wireless transmission module, a second processor, and a storage device. The method comprises processing an audio signal received by the audio signal input module with the first processor to generate transmission data, receiving the transmission data generated by the first processor with the first wireless transmission module and transmitting the transmission data with the first wireless transmission module to the second wireless transmission module using wireless transmission, receiving the transmission data with the second wireless transmission module from the first wireless transmission module using wireless transmission, processing the transmission data received by the second wireless transmission module with the second processor to generate storage data, and storing the storage data generated by the second processor with the storage device. The method further comprises when the central data processing subsystem (which is usually a computer system) is in a power-off state, the remote wireless data storage system operates as usual.

It is an advantage that the remote data processing subsystem is small enough to compete with the handy characteristic of the recording pen.

It is another advantage that the central data processing subsystem provides sufficient storage volume for long audio recording, wherein the central data processing subsystem can be implemented with a computer system (such as a laptop) so that only a few additional cost is need to enjoy the advantage provided by the present invention.

It is also an advantage that the above-mentioned central data processing subsystem implemented with a computer system has power-off processing functionality. When the computer system is in a power-off state, the remote wireless data storage system operates as usual, and transmits real time audio recording information wirelessly from the remote data processing subsystem to the central data processing subsystem.

It is also an advantage that the remote data processing subsystem utilizes the sufficient storage volume provided by the central data processing subsystem and transmits real time audio recording information wirelessly to the central data processing subsystem. Therefore, the cable connection such as that between the recording pen and the computer system for data storage is not needed anymore. As a result, the remote wireless data storage system can perform continuous audio recording while the user activity (such as a meeting) will not be interrupted.

These and other objectives of the present invention will no doubt become obvious to those of ordinary skill in the art after reading the following detailed description of the preferred embodiment that is illustrated in the various FIGURES and drawings.

### BRIEF DESCRIPTION OF DRAWINGS

FIG. 1 is a block diagram of an audio processing apparatus installed in a computer system according to the prior art.

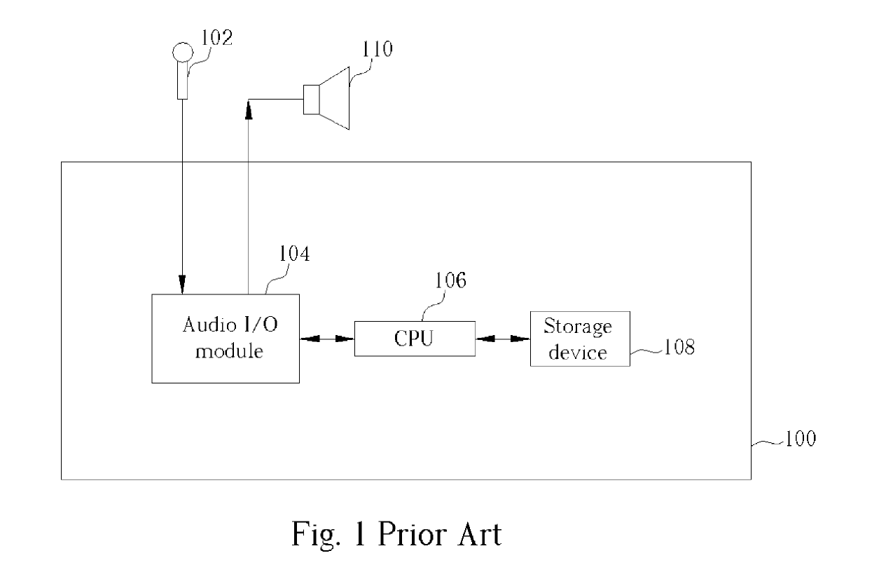

FIG. 2 is a block diagram of an audio processing apparatus installed in a computer system according to the prior art.

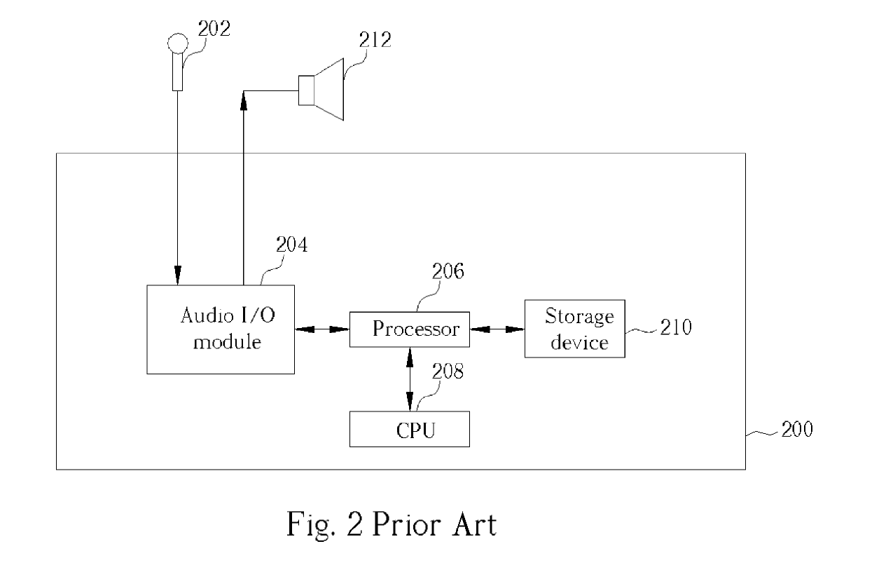

FIG. 3 is a block diagram of an audio processing apparatus installed in a computer system according to the prior art.

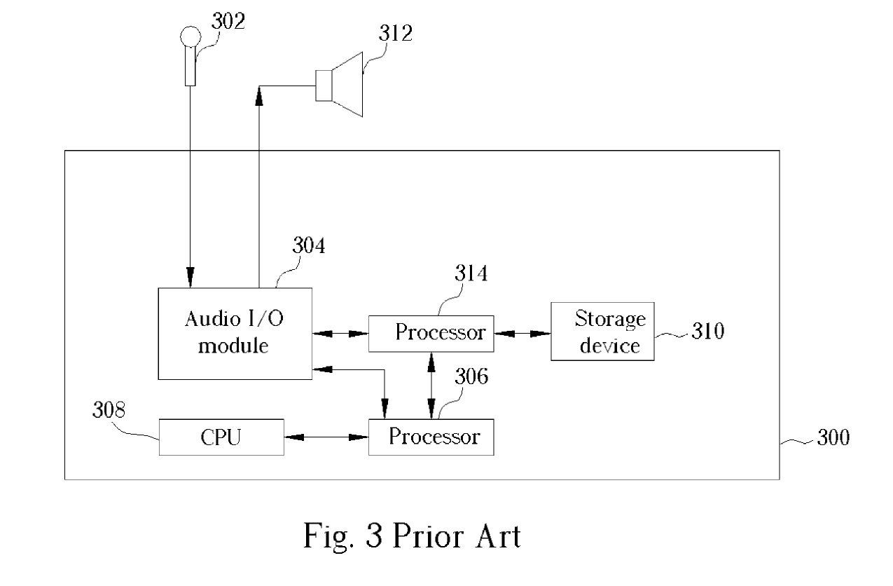

FIG. 4 is a block diagram of the first embodiment of the remote wireless data storage system of the present invention.

FIG. 5 is a block diagram of the second embodiment of the remote wireless data storage system of the present invention.

FIG. 6 is a flow chart diagram of the data storage method using the remote wireless data storage system of FIG. 4.

FIG. 7 is a flow chart diagram of playing recorded information of the data storage method using the remote wireless data storage system of FIG. 4.

FIG. 8 is a flow chart diagram of the data storage method using the remote wireless data storage system of FIG. 5.

FIG. 9 is a flow chart diagram of playing recorded information of the data storage method using the remote wireless data storage system of FIG. 5.

### DETAILED DESCRIPTION

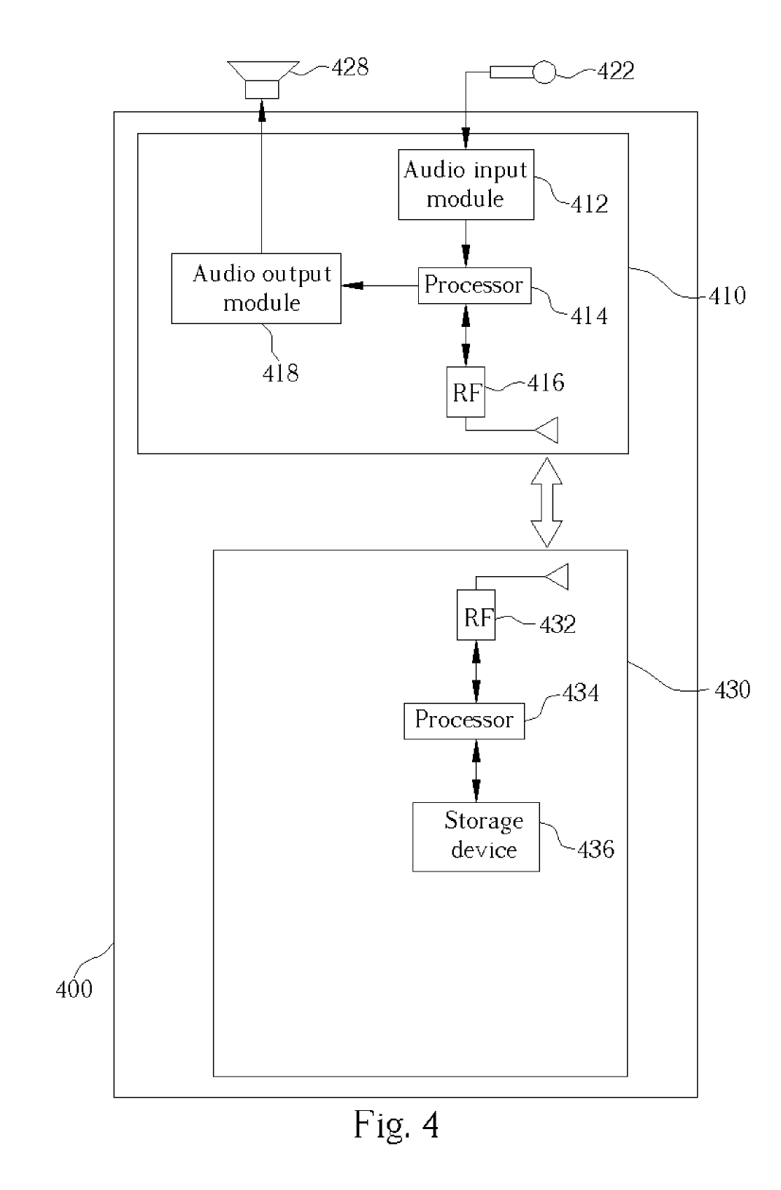

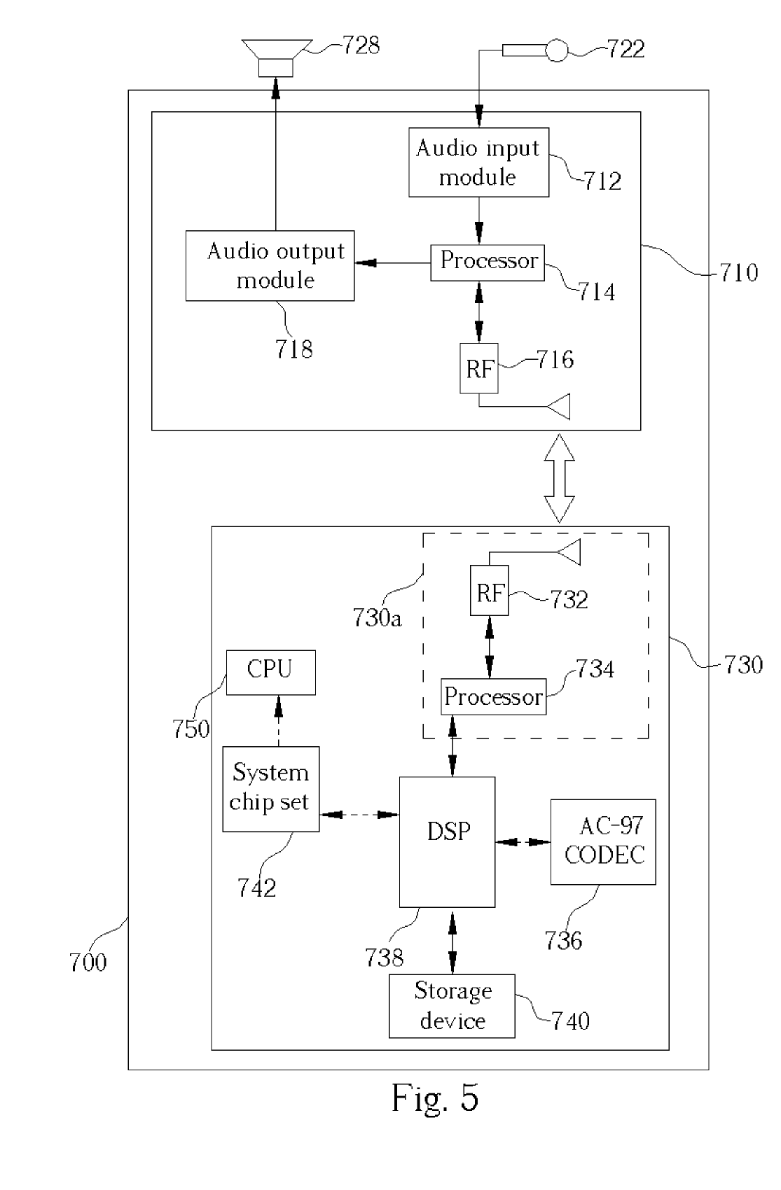

Please refer to FIG. 4 showing a block diagram of the first embodiment of the remote wireless data storage system of the present invention. As shown in FIG. 4, a remote wireless data storage system 400 for wireless data transmission and storage is provided. The remote wireless data storage system 400 comprises a remote data processing subsystem 410 for receiving an audio signal. The remote data processing subsystem 410 comprises an audio signal input module 412 for receiving the audio signal, a first processor 414 electrically connected to the audio signal input module 412 for processing the audio signal received by the audio signal input module 412 to generate transmission data (the first processor 414 can generate control signals such as ID, recording, playing, etc. and control the related processing), and a first wireless transmission module 416 (in the embodiments of the present invention, the related wireless transmission modules 416, 432, 716, 732 in FIG. 4 and FIG. 5 are shown as the conventional symbol “RF”, or “Radio Frequency”) electrically connected to the first processor 414 for wireless transmission of the transmission data.

The remote wireless data storage system 400 further comprises a central data processing subsystem 430 for data storage. The central data processing subsystem 430 comprises a second wireless transmission module 432 for receiving the transmission data from the first wireless transmission module 416, a second processor 434 electrically connected to the second wireless transmission module 432 for processing the transmission data received by the second wireless transmission module 432 to generate storage data (the second processor 434 can control the related processing according to the control signals such as ID, recording, playing, etc. received from the second wireless transmission module 432), and a storage device 436 electrically connected to the second processor 434 for storing the storage data generated by the second processor 434.

The storage device 436 shown in FIG. 4 (and the storage device 740 of the preferred embodiment shown in FIG. 5) can be a conventional hard disk drive, an optical storage device of a conventional computer system, or a storage device which does not hinder the implementation of the present invention. Furthermore, the processors 414, 434 (and related processors of the preferred embodiment shown in FIG. 5) can be microcontrollers, specialized chipsets, or other components which do not hinder the implementation of the present invention. In the following paragraphs, data named as “reconstructed” stand for data reconstructed with reverse processing of the related processors.

As shown in FIG. 4, the remote data processing subsystem 410 further comprises an audio signal output module 418 electrically connected to the first processor 414 for outputting a reconstructed audio signal, the second processor 434 processes the storage data retrieved from the storage device 436 to generate reconstructed transmission data, the second wireless transmission module 432 receives the reconstructed transmission data and outputs the reconstructed transmission data to the first wireless transmission module 416 using wireless transmission, the first wireless transmission module 416 receives the reconstructed transmission data from the second wireless transmission module 432, and the first processor 414 processes the reconstructed transmission data received by the first wireless transmission module 416 to generate the reconstructed audio signal. During the procedure of playing back of the embodiment of FIG. 4, the storage data retrieved from the storage device 436 (and the storage data retrieved from the storage device 740 of the preferred embodiment shown in FIG. 5) can be the storage data generated during the audio recording procedure of the present invention or similar storage data recorded in advance with audio recording procedures known in the art.

In the above-mentioned remote wireless data storage system 400, the antennas of the first wireless transmission module 416 and the second wireless transmission module 432 can be external antennas outside the wireless transmission modules 416, 432 or internal antennas included in the wireless transmission modules 416, 432 respectively. Similarly, the speaker 428 can be an external component outside the audio signal output module 418 or an internal component included in the audio signal output module 418. Then again, the microphone 422 can be an external component outside the audio signal input module 412 or an internal component included in the audio signal input module 412. The speaker 428 can be replaced with an earphone 428. While the implementation of the present invention is not hindered, the data transmission between any two components of the system 400 can be digital transmission or analog transmission. For example, the first processor 414 converts the audio signal to the transmission data of a specific digital format, and then the related wireless transmission modules 416, 432 perform wireless transmission using the specific digital format. The system 400 can do the same during the playing back procedure. As preferred, the implementation of the system 400 can be a Blue-tooth wireless transmission apparatus, whose typical working distance ranges from ten meters to fifteen meters, or an 802.11b wireless transmission apparatus, whose typical working distance is around a hundred meters. Furthermore, the first processor 414 can be implemented with a plurality of processors performing the same functionality of the processor 414. The functionality of the processor 414 includes additional encoding/decoding to enhance the transmission efficiency and the storage efficiency. The second processor 434 can be implemented with a single chip of full functionality or with a plurality of processors performing the same functionality of the processor 434. The functionality of the processor 434 includes data processing such as data comparing/altering, the aforementioned data converting, the data reading/writing (that is, the audio recording and playing back mentioned above), the overall control, and the aforementioned encoding/decoding for enhancement of the transmission efficiency and the storage efficiency. To clearly differentiate between the present invention and the prior art, the descriptions of such equivalent variations will not be repeated in the following.

In the remote wireless data storage system 400 of FIG. 4, the central data processing subsystem 430 can be a computer system or a processing system simplified from a computer system. Although the following embodiment is described with the text of a computer system, this is not a limitation. While the implementation of the present invention is not hindered, the present invention includes the aforementioned simplified systems with apparatuses similar to well-known computer systems (explained in the Description of the Prior Art) and related method.

As mentioned, the second processor 434 can be implemented with a single chip or a plurality of processors. This is described in the viewpoint of system structures. From another viewpoint, as computer system technology is well developed, those skilled in the art can implement the remote wireless data storage system of the present invention with various kinds of chipsets on hand and the hardware architecture of common computer systems. It is obvious that the implementation of the present invention using a common computer system includes the following. Firstly add the second wireless transmission module 432 and the processor (such as the processor 734 illustrated in FIG. 5) for wireless transmission and related control, providing the functionality of recording and playing back. Secondly notify the system to direct the data flow to some other processor (such as the processor 738 illustrated in FIG. 5) of the common computer system to perform further data processing, to store the data using the storage device of the computer system, or to play back the recorded audio information. Therefore, implementing the aforementioned central data processing subsystem 430 as a module installed in the computer system is the most cost-effective setup of the present invention. The objective of above is to utilize the hardware architecture on hand and apply the least modification to the hardware architecture to implement the central data processing subsystem 430.

The preferred embodiment of the present invention is described in the following. Please refer to FIG. 5 showing a block diagram of the second embodiment of the remote wireless data storage system of the present invention. As shown in FIG. 5, a remote wireless data storage system 700 for wireless data transmission and storage is provided. The remote wireless data storage system 700 comprises a remote data processing subsystem 710 for receiving an audio signal. The remote data processing subsystem 710 comprises an audio signal input module 712 for receiving the audio signal, a first processor 714 electrically connected to the audio signal input module 712 for processing the audio signal received by the audio signal input module 712 to generate transmission data, and a first wireless transmission module 716 electrically connected to the first processor 714 for wireless transmission of the transmission data.

The remote wireless data storage system 700 further comprises a central data processing subsystem 730 for data storage. The central data processing subsystem 730 installed in a computer system comprises a second wireless transmission module 732 for receiving the transmission data from the first wireless transmission module 716, a second processor 734 electrically connected to the second wireless transmission module 732 for processing the transmission data received by the second wireless transmission module 732 to generate digital data, a third processor 738 (which is a digital signal processor including the functionality such as I/O and storage control, MP3 playback, verbal signal compression/playback, noise-reduction, i.e. the specialized chipset 314 named as “Blue Bird VL+”) electrically connected to the second processor 734 for processing the digital data received from the second processor 734 to generate storage data, which can be played back by the computer system (the third processor 738 can play back the digital data, and the functionality will be described later), and a storage device 740 electrically connected to the third processor 738 for storing the storage data generated by the third processor 738.

The remote data processing subsystem 710 further comprises an audio signal output module 718 electrically connected to the first processor 714 for outputting a reconstructed audio signal. The third processor 738 processes the storage data retrieved from the storage device 740 to generate reconstructed digital data. The second processor 734 processes the reconstructed digital data received from the third processor 738 to generate reconstructed transmission data. The second wireless transmission module 732 receives the reconstructed transmission data and outputs the reconstructed transmission data to the first wireless transmission module 716 using wireless transmission. The first wireless transmission module 716 receives the reconstructed transmission data from the second wireless transmission module 732. The first processor 714 processes the reconstructed transmission data received by the first wireless transmission module 716 to generate the reconstructed audio signal. The storage data retrieved from the storage device 740 can be the storage data generated during the audio recording procedure of the present invention or similar storage data recorded in advance with audio recording procedures known in the art.

As shown in FIG. 5, the computer system (in which the central data processing subsystem 730 is installed) further comprises a system chipset 742 and a CPU 750 (Central Processing Unit). That is, the central data processing subsystem 730 further comprises the system chipset 742 and the CPU 750 for maintaining the operation of the computer system. As the choice of design, the second wireless transmission module 732, the second processor 734, the third processor 738, and the storage device 740 can operate as usual using the auxiliary power known in the art when the computer system is in a power-off state. Therefore, when the CPU 750, the system chipset 742, and the computer system is in a power-off state, the second wireless transmission module 732, the second processor 734, the third processor 738 (the “Blue Bird VL+” chipset), and the storage device 740 operate as usual to maintain the operation of the central data processing subsystem 730. In the embodiment of FIG. 5, the system chipset 742 is the South Bridge chipset. The computer system (in which the central data processing subsystem 730 is installed) further comprises an Audio CODEC 736 (Coder-Decoder) electrically connected to the third processor 738 for outputting a reconstructed audio signal. That is, the central data processing subsystem 730 further comprises the Audio CODEC 736, the “AC-97 CODEC” chipset 736 shown in FIG. 5. The third processor 738 processes the storage data retrieved from the storage device 740 to generate reconstructed digital data, and the Audio CODEC 736 processes the reconstructed digital data generated by the third processor 738 to generate the reconstructed audio signal.

In the central data processing subsystem 730 shown in FIG. 5, the central data processing subsystem component set 730a (that is, the second wireless transmission module 732 and the second processor 734) drawn with dashed lines can be installed in the computer system, can be a module such as other modules of the computer system known in the art, or can be an external part (which is separate module with respect to the computer system) such as a USB (Universal Serial Bus) module linked to the computer system through the USB port. Therefore, further provided by the present invention is a remote wireless data storage system component set for transmitting data to and for storing data in a computer system using wireless transmission. The remote wireless data storage system component set comprises the remote data processing subsystem 710 and the central data processing subsystem component set 730a. The component set 730a is an independent module, which can be plugged into a computer system to form the aforementioned central data processing subsystem 730, for receiving the transmission data from the remote data processing subsystem 710 and for data storage using the computer system. That is, the second processor 734 can output the digital data into the computer system to store the digital data in the computer system. Accordingly, the computer system can process the digital data stored in the computer system to generate reconstructed digital data, and the second processor 734 can process the reconstructed digital data generated by the computer system to generate the aforementioned reconstructed transmission data.

Furthermore, the remote data processing subsystem 710 in FIG. 5 can be implemented in the form of the recording pen known in the art or can be implemented in a Laser pointer, a touch pen for a touch panel of a computer system known in the art, or a remote controller for controlling the presentation applications known in the art to reduce the number of remote devices of the user. The functionality of the remote data processing subsystem 710 further includes volume adjustment, mode switching (for example, recording/turn-off/Laser-pointer switching), signal strength (or signal available/unavailable) indication LED (Light Emitting Diode/Display), transmission status indication LED (for example, continuous light represents power-on while blinking light represents performing wireless transmission), start/stop button(s) of audio recording and playing back, related control button(s) for remote control of the computer system (such as cursor movement, enter/execute, cancel), jog dial, memo (memorandum) button (for example, the memo button is lighten when the computer system sends a memo signal according to the schedule arranged in advance, and the light is turned off when the memo button is pressed), a buzzer (for the above-mentioned memo functionality, for reporting results of executed functions, or for reporting power-low such as electricity insufficiency), related button(s) of the touch pen, or related button(s) of the Laser pointer. It is preferred that an earphone jack, and even an earphone with remote control functionality (for example, a volume control dial/button or other control buttons) are provided.

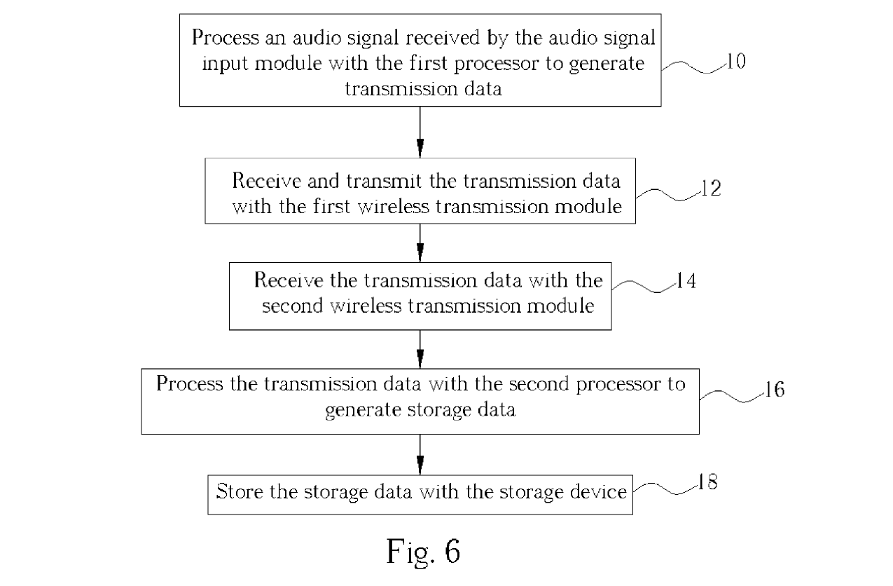

Please refer to FIG. 6 showing a flow chart diagram of the data storage method using the remote wireless data storage system 400 of FIG. 4. The related steps are described as follows.

Step 10: Process an audio signal received by the audio signal input module 412 with the first processor 414 to generate transmission data;
Step 12: Receive the transmission data generated by the first processor 414 with the first wireless transmission module 416 and transmit the transmission data with the first wireless transmission module 416 to the second wireless transmission module 432 using wireless transmission;
Step 14: Receive the transmission data with the second wireless transmission module 432 from the first wireless transmission module 416 using wireless transmission;
Step 16: Process the transmission data received by the second wireless transmission module 432 with the second processor 434 to generate storage data; and
Step 18: Store the storage data generated by the second processor 434 with the storage device 436.

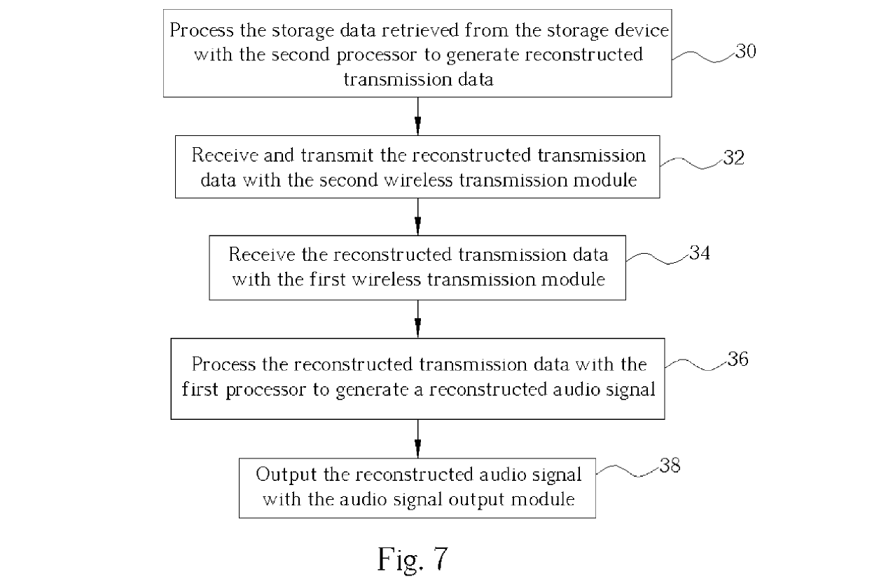

As mentioned, the present invention provides the playing back functionality with the data flow reversed. Of concern, the storage data of the following steps can be the storage data generated during the audio recording procedure of the present invention or similar storage data recorded in advance with audio recording procedures known in the art. Please refer to FIG. 7 showing a flow chart diagram of playing recorded information of the data storage method using the remote wireless data storage system 400 of FIG. 4. The related steps are described as follows.
Step 30: Process the storage data retrieved from the storage device 436 with the second processor 434 to generate reconstructed transmission data;
Step 32: Receive the reconstructed transmission data generated by the second processor 434 with the second wireless transmission module 432 and transmit the reconstructed transmission data with the second wireless transmission module 432 to the first wireless transmission module 416 using wireless transmission;
Step 34: Receive the reconstructed transmission data with the first wireless transmission module 416 from the second wireless transmission module 432;
Step 36: Process the reconstructed transmission data received by the first wireless transmission module 416 with the first processor 414 to generate a reconstructed audio signal; and

Step 38: Output the reconstructed audio signal with the audio signal output module 418.

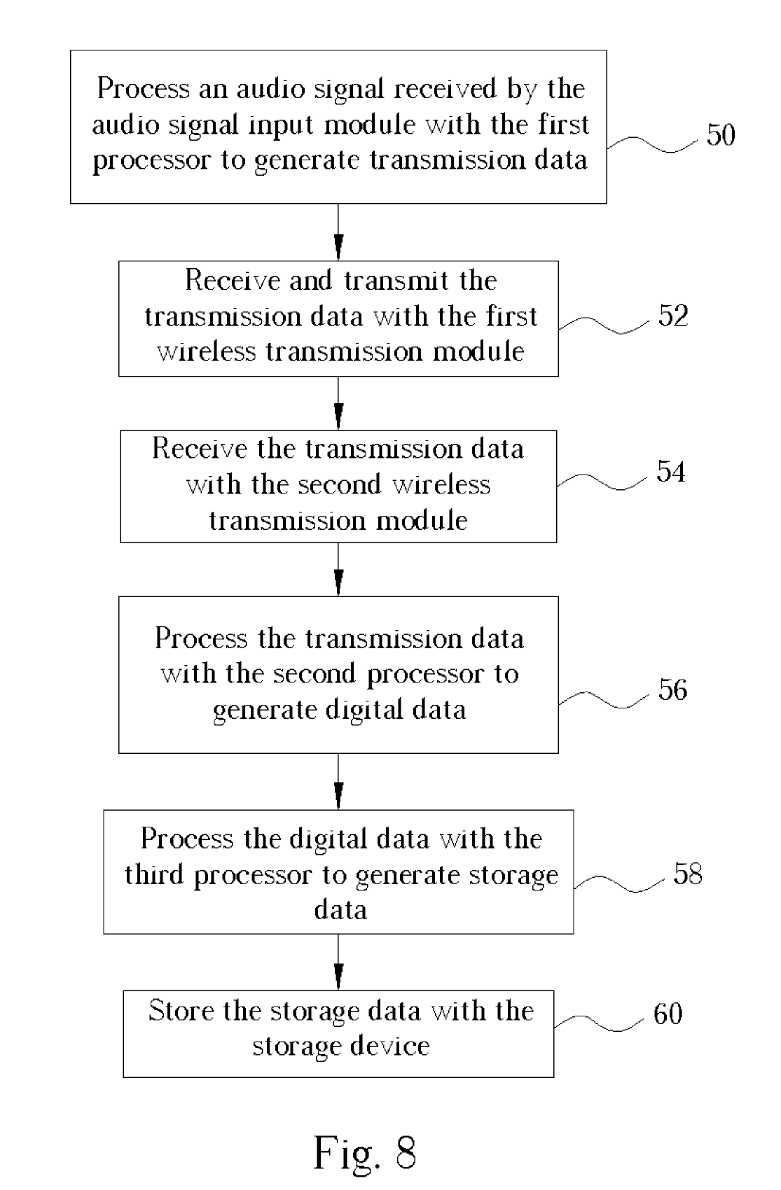

The following paragraphs relate to the operation procedures of the embodiment of FIG. 5 while those mentioned above relate to the operation procedures of the embodiment of FIG. 4. Please refer to FIG. 8 showing a flow chart diagram of the data storage method using the remote wireless data storage system 700 of FIG. 5. As the aforementioned choice of design, the second wireless transmission module 732, the second processor 734, the third processor 738, and the storage device 740 can operate as usual using the auxiliary power known in the art when the computer system is in a power-off state. Therefore, no matter if the CPU 750 and the computer system are in a power-off state or a power-on state, the method of FIG. 8 is workable. The related steps are described as follows.
Step 50: Process an audio signal received by the audio signal input module 712 with the first processor 714 to generate transmission data;
Step 52: Receive the transmission data generated by the first processor 714 with the first wireless transmission module 716 and transmit the transmission data with the first wireless transmission module 716 to the second wireless transmission module 732 using wireless transmission;
Step 54: Receive the transmission data with the second wireless transmission module 732 from the first wireless transmission module 716;
Step 56: Process the transmission data received by the second wireless transmission module 732 with the second processor 734 to generate digital data;
Step 58: Process the digital data generated by the second processor 734 with the third processor 738 to generate storage data; and
Step 60: Store the storage data generated by the third processor 738 with the storage device 740.

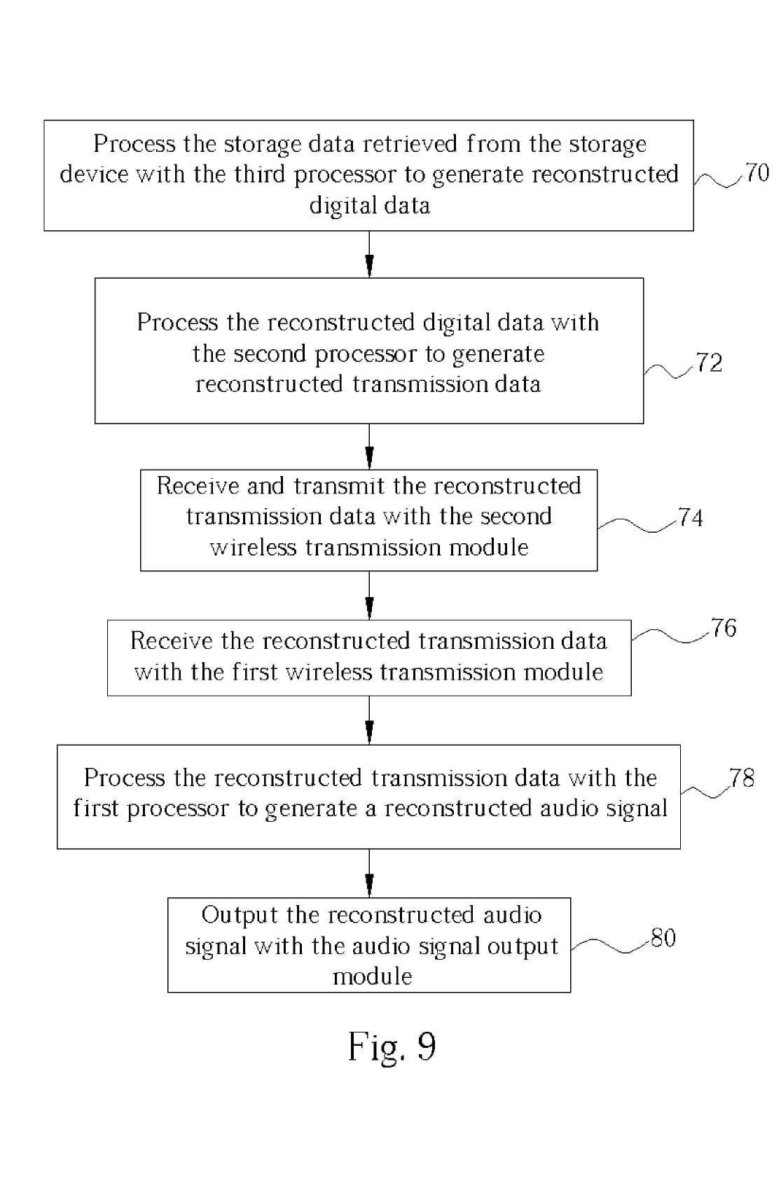

As mentioned, the present invention provides the playing back functionality with the data flow reversed. Of concern, the storage data of the following steps can be the storage data generated during the audio recording procedure of the present invention or similar storage data recorded in advance with audio recording procedures known in the art. Please refer to FIG. 9 showing a flow chart diagram of playing recorded information of the data storage method using the remote wireless data storage system 700 of FIG. 5. As the aforementioned choice of design, the second wireless transmission module 732, the second processor 734, the third processor 738, and the storage device 740 can operate as usual using the auxiliary power known in the art when the computer system is in a power-off state. Therefore, no matter if the CPU 750 and the computer system are in a power-off state or a power-on state, the method of FIG. 9 is workable. The related steps are described as follows.
Step 70: Process the storage data retrieved from the storage device 740 with the third processor 738 to generate reconstructed digital data;
Step 72: Process the reconstructed digital data generated by the third processor 738 with the second processor 734 to generate reconstructed transmission data;
Step 74: Receive the reconstructed transmission data generated by the second processor 734 with the second wireless transmission module 732 and transmit the reconstructed transmission data with the second wireless transmission module 732 to the first wireless transmission module 716 using wireless transmission;
Step 76: Receive the reconstructed transmission data with the first wireless transmission module 716 from the second wireless transmission module 732 using wireless transmission;
Step 78: Process the reconstructed transmission data received by the first wireless transmission module 716 with the first processor 714 to generate a reconstructed audio signal; and
Step 80: Output the reconstructed audio signal with the audio signal output module 718.

As mentioned, the remote wireless data storage system 700 (or the computer system, in which the central data processing subsystem 730 is installed) includes the Audio CODEC 736. Corresponding to the system 700 provided by the present invention, the method of the present invention further comprises processing the storage data retrieved from the storage device 740 with the third processor 738 to generate reconstructed digital data, and processing the reconstructed digital data generated by the third processor 738 with the Audio CODEC 736 to generate a reconstructed audio signal. Therefore, the paths of playing back the reconstructed audio signal includes not only the path through the wireless transmission modules 716, 732, the processor 714, and the audio signal output module 718, but also the path through the Audio CODEC 736.

As mentioned, the remote wireless data storage system 700 (or the computer system, in which the central data processing subsystem 730 is installed) includes the CPU 750 for maintaining the operation of the computer system. Corresponding to the system 700 provided by the present invention, the method of the present invention further comprises when the computer system is in a power-off state, the second wireless transmission module 732, the second processor 734, the third processor 738, and the storage device 740 operate as usual to maintain the operation of the central data processing subsystem 730.

To summarize, the present invention provides a method and a device for wireless data transmission and storage. The device is a remote wireless data storage system comprising a remote data processing subsystem and a central data processing subsystem. The central data processing subsystem can be implemented in a computer system. In a variation of the embodiment, the central data processing subsystem consists of a computer and a central data processing subsystem component set.

In contrast to the prior art, the remote data processing subsystem is small enough to compete with the handy characteristic of the recording pen. The remote data processing subsystem also provides the wireless verbal control functionality (such as verbal controlled power-on/off, playing back, opening/closing window, etc.).

It is another advantage that the central data processing subsystem provides sufficient storage volume for long audio recording, wherein the central data processing subsystem can be implemented with a computer system (such as a laptop) so that only a few additional cost is need to enjoy the advantage provided by the present invention.

It is also an advantage that the above-mentioned central data processing subsystem implemented with a computer system has power-off processing functionality. When the computer system is in a power-off state, the remote wireless data storage system operates as usual.

It is also an advantage that the remote data processing subsystem utilizes the sufficient storage volume provided by the central data processing subsystem and transmits real time audio recording information wirelessly to the central data processing subsystem. Therefore, the cable connection such as that between the recording pen and the computer system for data storage is not needed anymore. As a result, the remote wireless data storage system can perform continuous audio recording while the user activity (such as a meeting) will not be interrupted.

Those skilled in the art will readily observe that numerous modifications and alterations of the device may be made while retaining the teachings of the invention. Accordingly, the above disclosure should be construed as limited only by the metes and bounds of the appended claims.

1. A remote wireless data storage system for wireless data transmission and storage, the remote wireless data storage system comprising:
a remote data processing subsystem for receiving an audio signal, the remote data processing subsystem comprising:
an audio signal input module for receiving the audio signal;
a first processor electrically connected to the audio signal input module for processing the audio signal received-by the audio signal input module to generate transmission data; and
a first wireless transmission module electrically connected to the first processor for wireless transmission of the transmission data; and
a central data processing subsystem for data storage, the central data processing subsystem comprising:
a second wireless transmission module for receiving the transmission data from the first wireless transmission module;
a second processor electrically connected to the second wireless transmission module for processing the transmission data received by the second wireless transmission module to generate storage data; and
a storage device electrically connected to the second processor for storing the storage data generated by the second processor.

2. The system of claim 1, wherein the remote data processing subsystem further comprises an audio signal output module electrically connected to the first processor for outputting a reconstructed audio signal, the second processor processes the storage data retrieved from the storage device to generate reconstructed transmission data, the second wireless transmission module receives the reconstructed transmission data and outputs the reconstructed transmission data to the first wireless transmission module using wireless transmission, the first wireless transmission module receives the reconstructed transmission data from the second wireless transmission module, and the first processor processes the reconstructed transmission data received by the first wireless transmission module to generate the reconstructed audio signal.

3. The system of claim 1, wherein the central data processing subsystem is a computer system.

4. A remote wireless data storage system for wireless data transmission and storage, the remote wireless data storage system comprising:
a remote data processing subsystem for receiving an audio signal, the remote data processing subsystem comprising:
an audio signal input module for receiving the audio signal;
a first processor electrically connected to the audio signal input module for processing the audio signal received-by the audio signal input module to generate transmission data; and
a first wireless transmission module electrically connected to the first processor for wireless transmission of the transmission data; and
a central data processing subsystem for data storage, the central data processing subsystem installed in a computer system comprising:
a second wireless transmission module for receiving the transmission data from the first wireless transmission module;
a second processor electrically connected to the second wireless transmission module for processing the transmission data received by the second wireless transmission module to generate digital data;
a third processor electrically connected to the second processor for processing the digital data received from the second processor to generate storage data; and
a storage device electrically connected to the third processor for storing the storage data generated by the third processor.

5. The system of claim 4, wherein the remote data processing subsystem further comprises an audio signal output module electrically connected to the first processor for outputting a reconstructed audio signal, the third processor processes the storage data retrieved from the storage device to generate reconstructed digital data, the second processor processes the reconstructed digital data received from the third processor to generate reconstructed transmission data, the second wireless transmission module receives the reconstructed transmission data and outputs the reconstructed transmission data to the first wireless transmission module using wireless transmission, the first wireless transmission module receives the reconstructed transmission data from the second wireless transmission module, and the first processor processes the reconstructed transmission data received by the first wireless transmission module to generate the reconstructed audio signal.

6. The system of claim 4, wherein the computer system comprises a system chipset and a CPU (Central Processing Unit) for maintaining the operation of the computer system; and when the computer system is in a power-off state, the second wireless transmission module, the second processor, the third processor, and the storage device operate as usual to maintain the operation of the central data processing subsystem.

7. The system of claim 6, wherein the system chipset is the South Bridge chipset.

8. The system of claim 4, wherein the computer system comprises an Audio CODEC (Coder-Decoder) electrically connected to the third processor for outputting a reconstructed audio signal; the third processor processes the storage data retrieved from the storage device to generate reconstructed digital data, and the Audio CODEC processes the reconstructed digital data generated by the third processor to generate the reconstructed audio signal.

9. A remote wireless data storage system component set for transmitting data to and for storing data in a computer system using wireless transmission, the remote wireless data storage system component set comprising:
a remote data processing subsystem for receiving an audio signal, the remote data processing subsystem comprising:
an audio signal input module for receiving the audio signal;
a first processor electrically connected to the audio signal input module for processing the audio signal received by the audio signal input module to generate transmission data; and
a first wireless transmission module electrically connected to the first processor for wireless transmission of the transmission data; and
a central data processing subsystem component set, which can be plugged into the computer system to form a central data processing subsystem, for receiving the transmission data from the remote data processing subsystem and for data storage using the computer system, the central data processing subsystem component set comprising:
a second wireless transmission module for receiving the transmission data from the first wireless transmission module; and
a second processor electrically connected to the second wireless transmission module for processing the transmission data received by the second wireless transmission module to generate digital data, and for outputting the digital data into the computer system to store the digital data in the computer system.

10. The remote wireless data storage system component set of claim 9, wherein the remote data processing subsystem further comprises an audio signal output module electrically connected to the first processor for outputting a reconstructed audio signal, the computer system processes the digital data stored in the computer system to generate reconstructed digital data, the second processor processes the reconstructed digital data generated by the computer system to generate reconstructed transmission data, the second wireless transmission module receives the reconstructed transmission data and outputs the reconstructed transmission data to the first wireless transmission module using wireless transmission, the first wireless transmission module receives the reconstructed transmission data from the second wireless transmission module, and the first processor processes the reconstructed transmission data received by the first wireless transmission module to generate the reconstructed audio signal.

11. The remote wireless data storage system component set of claim 9, wherein when the computer system is in a power-off state, the second wireless transmission module and the second processor operate as usual to maintain the operation of the central data processing subsystem.

12. A data storage method using a remote wireless data storage system, wherein the remote wireless data storage system comprises a remote data processing subsystem and a central data processing subsystem, the remote data processing subsystem comprises an audio signal input module, a first processor, and a first wireless transmission module, and the central data processing subsystem comprises a second wireless transmission module, a second processor, and a storage device; the method comprising:
processing an audio signal received by the audio signal input module with the first processor to generate transmission data;
receiving the transmission data generated by the first processor with the first wireless transmission module and transmitting the transmission data with the first wireless transmission module to the second wireless transmission module using wireless transmission;
receiving the transmission data with the second wireless transmission module from the first wireless transmission module using wireless transmission;
processing the transmission data received by the second wireless transmission module with the second processor to generate storage data; and
storing the storage data generated by the second processor with the storage device.

13. The method of claim 12, wherein the remote data processing subsystem further comprises an audio signal output module for outputting a reconstructed audio signal; the method further comprising:
processing the storage data retrieved from the storage device with the second processor to generate reconstructed transmission data;
receiving the reconstructed transmission data generated by the second processor with the second wireless transmission module and transmitting the reconstructed transmission data with the second wireless transmission module to the first wireless transmission module using wireless transmission;
receiving the reconstructed transmission data with the first wireless transmission module from the second wireless transmission module; and
processing the reconstructed transmission data received by the first wireless transmission module with the first processor to generate the reconstructed audio signal.

14. A data storage method using a remote wireless data storage system, wherein the remote wireless data storage system comprises a remote data processing subsystem and a central data processing subsystem, the remote data processing subsystem comprises an audio signal input module, a first processor, and a first wireless transmission module, the central data processing subsystem comprises a second wireless transmission module, a second processor, and a computer system, and the computer system comprises a third processor for controlling data storage and a storage device for data storage; the method comprising:
processing an audio signal received by the audio signal input module with the first processor to generate transmission data;
receiving the transmission data generated by the first processor with the first wireless transmission module and transmitting the transmission data with the first wireless transmission module to the second wireless transmission module using wireless transmission;
receiving the transmission data with the second wireless transmission module from the first wireless transmission module;
processing the transmission data received by the second wireless transmission module with the second processor to generate digital data;
processing the digital data generated by the second processor with the third processor to generate storage data; and
storing the storage data generated by the third processor with the storage device.

15. The method of claim 14, wherein the remote data processing subsystem further comprises an audio signal output module for outputting a reconstructed audio signal; the method further comprising:
processing the storage data retrieved from the storage device with the third processor to generate reconstructed digital data;
processing the reconstructed digital data generated by the third processor with the second processor to generate reconstructed transmission data;
receiving the reconstructed transmission data generated by the second processor with the second wireless transmission module and transmitting the reconstructed transmission data with the second wireless transmission module to the first wireless transmission module using wireless transmission;
receiving the reconstructed transmission data with the first wireless transmission module from the second wireless transmission module using wireless transmission; and
processing the reconstructed transmission data received by the first wireless transmission module with the first processor to generate the reconstructed audio signal.

16. The method of claim 14, wherein the computer system further comprises an Audio CODEC (Coder-Decoder); the method further comprising:
processing the storage data retrieved from the storage device with the third processor to generate reconstructed digital data; and
processing the reconstructed digital data generated by the third processor with the Audio CODEC to generate a reconstructed audio signal.

17. The method of claim 14, wherein the computer system further comprises a CPU (Central Processing Unit) for maintaining the operation of the computer system; the method further comprising: when the computer system is in a power-off state, the second wireless transmission module, the second processor, the third processor, and the storage device operate as usual to maintain the operation of the central data processing subsystem.
